(19) United States
(12) Patent Application Publication
(10) Pub. No.: US 2024/0325128 A1
(43) Pub. Date: Oct. 3, 2024

(54) DENTAL PROSTHESIS SUPPORT DEVICE

(71) Applicant: Frédéric VALERE, VENTIMIGLIA (IT)

(72) Inventor: Frédéric VALERE, VENTIMIGLIA (IT)

(21) Appl. No.: 18/681,246

(22) PCT Filed: Jun. 17, 2022
(86) PCT No.: PCT/EP2022/066601

§ 371 Date: Feb. 5, 2024

(30) Foreign Application Priority Data
Aug. 6, 2021 (FR) FR2108548

(51) Int. Cl. A61C 13/275; A61C 7/08

(52) U.S. Cl. CPC A61C 13/275; A61C 7/08

(57) ABSTRACT

A dental prosthesis support device including: a support strip secured to a dental prosthesis; and connectors which are designed, when in use, to be attached to the teeth of the patient, enclose a dental free space and onto which the support strip detachably engages such that the dental prosthesis fills said space; the support strip having a profile to cover only the lingual surface of the teeth while leaving the other surfaces of the teeth free; the connectors configured to be attached to the lingual surface of the teeth; and the support strip includes pockets into which the connectors fit elastically.

### TECHNICAL FIELD

The invention relates to a dental prosthesis support device.

The technical field of the invention is that of devices for holding a dental prosthesis in place in a patient's mouth.

### BACKGROUND

Dental implants or dental anchors are used to replace missing teeth. An implant generally comprises a screw (made of titanium, zirconium or polymer) inserted in the upper or lower jawbone and intended to create an anchor capable of receiving a dental prosthesis. The fitting of the implant is carried out in several steps and generally takes place under anesthetic. During a main surgery step, the practitioner fits the implants by screwing it into the bone. During a healing period of several months, the bone is reformed around the implant and surrounds it. Once the implant is anchored to the bone, an abutment is fitted to prepare the gum opening which will serve as a support for the prosthesis. The prosthesis is finally fitted on the abutment and definitively sealed.

While the dental prosthesis has not been fitted on the abutment, the patient finds themselves with a gap in the dental arch, at the implantation site. This gap can be particularly unsightly and cause undesirable migration of other teeth. Malocclusions, diastemas or tremas may then appear and disrupt the muscle function of the jaws or the functional relationships between the teeth.

The invention aims to solve these problems.

A further aim of the invention is that of providing a dental appliance which is particularly attractive, hygienic and comfortable for the patient.

### SUMMARY

The solution as proposed by the invention is a dental prosthesis support device comprising: —a support strip secured to a dental prosthesis; —connectors which are designed, when in use, to be attached to the teeth of the patient, enclose a dental free space and onto which the support strip detachably engages such that the dental prosthesis fills said space; —the support strip is profiled to cover only the lingual surface of the teeth while leaving the other surfaces of said teeth free;
the connectors are configured to be attached to the lingual surface of the teeth;
the support strip comprises pockets into which the connectors fit elastically.

The support strip only being in the lingual position, it is consistently invisible and hence particularly attractive. Even if it were to be discolored in contact with cigarette smoke or coffee, it does not become unsightly. Furthermore, as the strip and the connectors leave the occlusal and incisal surface of the teeth entirely free, the patient is perfectly able to cut, chew and eat without having to remove said strip. Moreover, on account of their lingual position, the connectors are no longer a source of discomfort and/or irritation at the patient's lips and/or cheeks. Finally, the strip can be easily removed and replaced by the patient themselves, without having to refer to a practitioner.

Further advantageous features of the invention are listed below. Each of these features can be considered alone or in combination with the remarkable features defined above, and be the subject, where applicable, of one or more divisional patent applications:

According to an embodiment, the dental prosthesis is attached to the support strip by bonding, welding or fitting.

According to an embodiment, the dental prosthesis has a lingual surface which is bonded to the support strip.

According to an embodiment, the dental prosthesis and the support strip are a single molded, machined or 3D-printed unitary piece.

According to an embodiment, each connector includes a spherical connection head.

According to an embodiment, each connector includes: —a base having an attachment surface adapted to be attached against the lingual surface of a tooth;
a connection head in line with the base and into which one of the pockets of the support strip fits.

According to an embodiment, the connection head is distant from the base, a flange connecting said base from said head.

According to an embodiment, each connector includes: —a connection head into which one of the pockets of the support strip fits; —an attachment surface adapted to be attached against the lingual surface of a tooth; —the attachment surface consists of a flat section arranged on the connection head.

According to an embodiment, the connection head has one of the following shapes: ovoid, elongated ellipsoid, sphere, cube, parallelepiped, polyhedron, prism, cone, pyramid, cylinder; or consists of a combination of two or more of these different shapes.

According to an embodiment, the support strip is flexible.

According to an embodiment, the support strip is rigid.

According to an embodiment, the support strip has portions or areas having distinct moduli of elasticity.

A further aspect not covered by the present invention relates to a maxillary expansion appliance comprising: —a maxillary expansion plate configured to cooperate with a plurality of teeth of a patient's maxillary dental arch so as to expand said patient's palate; —connectors adapted to be attached to said teeth and on which the maxillary expansion plate is detachably engaged; —the connectors and the plate cooperate so as to apply at least one stress tending to expand the palate when the dental appliance is worn by the patient; —the maxillary expansion plate is profiled to cover the palatal arch and only the lingual surface of the teeth while leaving the other surfaces of said teeth free; —the connectors are configured to be attached against the lingual surface of the teeth; —the maxillary expansion plate comprises pockets into which the connectors fit elastically.

A further aspect not covered by the present invention relates to a dental appliance comprising: —a dental aligner configured to cooperate with at least one tooth of a patient's dental arch so as to move it to a desired position; —connectors adapted to be attached to teeth of the dental arch and on which the dental aligner is detachably engaged; —the connectors and the aligner cooperate so as to apply one treatment stress on at least said tooth when the dental appliance is worn by the patient. The dental aligner is formed from a flexible strip to cover only the lingual surface of the teeth while leaving the other surfaces of said teeth free. Furthermore, the connectors are configured to be attached against the lingual surface of the teeth. Moreover, the flexible strip comprises pockets into which the connectors fit elastically.

### BRIEF DESCRIPTION OF THE FIGURES

Further advantages and features of the invention will emerge more clearly on reading the description of a preferred embodiment hereinafter, with reference to the appended drawings, made by way of indicative and non-limiting examples and wherein:

FIG. 1 is a cross-sectional schematic view of a dental appliance worn by a patient.

FIG. 2a is a cross-sectional schematic view of a dental aligner adapted to be positioned at a patient's maxillary dental arch.

FIG. 2b is a cross-sectional schematic view of a dental aligner adapted to be positioned at a patient's mandibular dental arch.

FIG. 3a, FIG. 3b and FIG. 3c schematically represent, respectively, a schematic view, a profile view and a top view of a connector used in the invention.

FIG. 4a, FIG. 4b and FIG. 4c schematically represent, respectively, a schematic view, a profile view and a top view of a connector used in the invention, and on which different stress zones are represented schematically.

FIG. 5 illustrates the fitting of a dental appliance at a patient's mandibular dental arch and maxillary dental arch.

FIG. 6 is a cross-sectional schematic view of a dental appliance worn by a patient, the aligner disposed at the maxillary dental arch having a palatal extension engaged with an anchor screw.

FIG. 7 is a cross-sectional schematic view of a dental aligner used in the appliance of FIG. 6.

FIG. 8 is a cross-sectional schematic view of a dental appliance according to a further embodiment, disposed at a patient's mandibular dental arch.

FIG. 9 is a cross-sectional schematic view of a removable splint used in the appliance of FIG. 8.

FIG. 10 illustrates the fitting of a dental appliance according to a further embodiment, at a patient's maxillary dental arch.

FIG. 11 is a sectional schematic view along A-A of FIG. 10.

FIG. 12a and FIG. 12b illustrate the use of a dental appliance as a temporary tooth support.

FIG. 13a and FIG. 13b are schematic profile and top views, respectively, of a connector according to an alternative embodiment.

FIG. 14 is a cross-sectional schematic view of a dental appliance according to a further embodiment, disposed at a patient's mandibular dental arch.

### DETAILED DESCRIPTION OF THE EMBODIMENTS

For the purposes of clarity, the following clarifications are provided for certain terms used in the description and the claims:
“Lingual surface” denotes the dental surface oriented toward the tongue (for mandibular arch teeth) or oriented toward the palate (for maxillary arch teeth).
As used here, unless specified otherwise, the use of the ordinal adjectives “first”, “second”, etc., to describe an object merely indicates that different occurrences of similar objects are mentioned and does not imply that the objects thus described must be in a given sequence, whether over time, in space, in a ranking or in any other way.
Similarly, the use of the adjectives “right/left”, “front/rear”, “top/bottom”, etc., are used to describe simply the position of an object in the configuration of the appended figures, but does not necessarily imply that in practice, similar objects are in the same position.
“X and/or Y” denotes: X only, or Y only, or X and Y.
As a general rule, it will be appreciated that the different drawings are not drawn to scale from one figure to another or within a given figure, and in particular that the objects may be drawn arbitrarily to facilitate reading of the drawings.

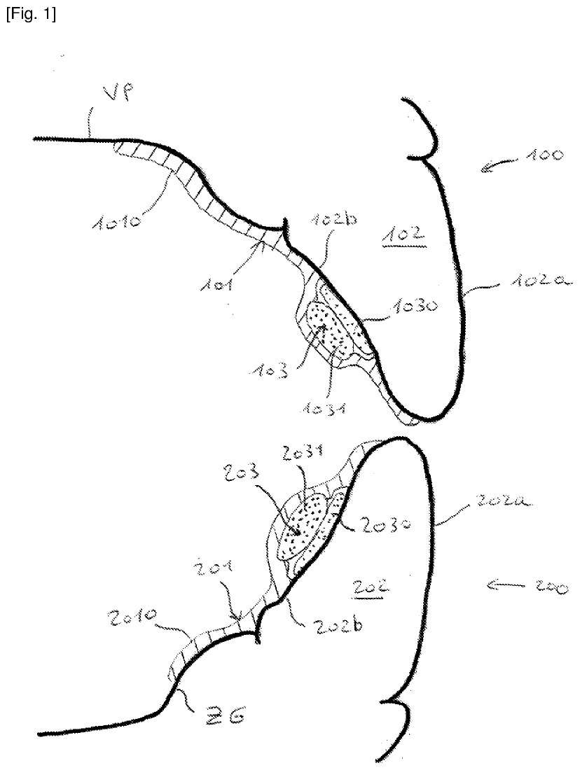

FIG. 1 illustrates a first dental aligner 101 which cooperates with a first tooth 102 of a maxillary dental arch 100 and a second dental aligner 201 which cooperates with a second tooth 202 of a mandibular dental arch 200. In practice, each aligner 101, 201 cooperates with a plurality of teeth, for example between 2 and 16 teeth. Depending on the nature of the treatment, only one of the two arches 100 or 200 may be equipped with an aligner. The aligner 101, 201 may be used to move a single tooth or a plurality of teeth of a dental arch.

The teeth 102, 202 have a vestibular surface 102a, 202a (oriented toward the cheek or the lip), a lingual surface 102b, 202b, an occlusal or incisal surface (top), a mesial surface (to the front) and a distal surface (to the rear). According to a feature, the aligner 101, 201 is formed of a flexible strip profiled to cover only the lingual surfaces 102b, 202b of the teeth. All the other surfaces of the teeth 102, 202 are left free, in particular the occlusal or incisal surfaces, which allows the patient to be able to eat while keeping the aligner 101, 201 in their mouth.

According to an embodiment, this flexible strip covers and is in contact with the entirety of the lingual surfaces 102b, 202b (except at the connectors 103, 203) such that food cannot be inserted between them. According to a further embodiment, this flexible strip only covers and is in contact with only a part of the lingual surfaces 102b, 202b, for example with the part located between the connector 103, 203 and the occlusal or incisal surface.

According to a preferred embodiment, the aligner 101, 201 is made of one piece. It may however be formed of several distinct portions, each portion being used to specifically treat the movement of one or more teeth.

The aligner 101, 201 is advantageously made of a transparent or translucent polymer material such that it is not visible when worn. The polymer material used may for example belong to the following family: polymer (meth) acrylate; silicone; polyester; polyurethane; polycarbonate; polyethylene terephthalate glycol (PETG); polypropylene; ethylene-vinyl acetate; or any other suitable polymer.

According to an embodiment, the aligner 101, 201 is obtained by molding, thermoforming, 3D printing or any other process suitable for a person skilled in the art.

In a manner known to a person skilled in the art, the determination of the dental movements by the aligner 101, 201 may commence with a modeling of the initial position of the teeth, for example using an impression, or preferably an intraoral scan making it possible to obtain a digital modeling of the dental arches. The treatment plan defining the sequence of dental movements to a desired final position may be determined by the practitioner and/or by specific software such as DeltaFace® software marketed by Coruo. This sequence will determine the configuration of the aligners at each step of the treatment plan. At each step, the teeth are moved progressively, for example by 0.1 mm to 0.2 mm in different spatial planes. There may be between 10 and 100 steps and therefore between 10 and 100 different aligner models. At the start of each step of the treatment, when it is placed on the teeth, the aligner is adjusted to the intermediate (or final) alignment that the teeth should have at the end of said step, such that aligner model exerts one or more stresses on said teeth to be moved. The flexibility of the aligner enables it to deform elastically to the alignment that the tooth has at the start of the step of the treatment. By attempting to return to its initial shape (shape memory), the aligner exerts one or stresses on the teeth. The teeth are then adjusted progressively to the shape of the aligner. When the teeth are perfectly adjusted to the shape of an aligner, i.e., when the teeth have moved to the planned arrangement, the deformation of the aligner and therefore the associated treatment force, becomes smaller, or even zero. The aligner is then changed to move to the next step of the treatment. In practice, the patient is supplied with a set of aligners, which they use sequentially to each step of the treatment, without needing to consult a practitioner. At the end of the treatment, the final aligner (or another aligner adjusted to the final alignment) may be used as a retainer, said aligner is then passive, i.e., it does not stress any teeth.

The flexibility of the aligner 101, 201 is essentially dependent on its shape, its material and its thickness. This flexibility corresponds to the ability of the aligner to deform in an elastic and controlled manner, to exert a treatment stress on one or more teeth in order to move it (them).

According to an embodiment, the thickness of the aligner 101, 201 is between 0.1 mm and 2 mm, advantageously between 0.5 mm and 1 mm, preferably between 0.6 mm and 0.8 mm. This thickness may be constant or on the other hand varied such that the aligner 101, 201 has different portions or zones of distinct thickness having different moduli of elasticity. It is thus possible to adapt the intensity of the stress to be applied on a particular tooth to be treated. A similar result is obtained using an aligner formed of a plurality of portions or zones consisting of materials having distinct moduli of elasticity. Each portion or zone may thus generate a stress the intensity of which is specific thereto.

The aligner 101, 201 is held in position by means of connectors 103, 203 configured to be attached against the lingual surface 102b, 202b of the teeth 102, 202. The aligner 101, 201 is detachably engaged (manually and without an instrument) on the connectors 103, 203 as explained hereinabove in the description.

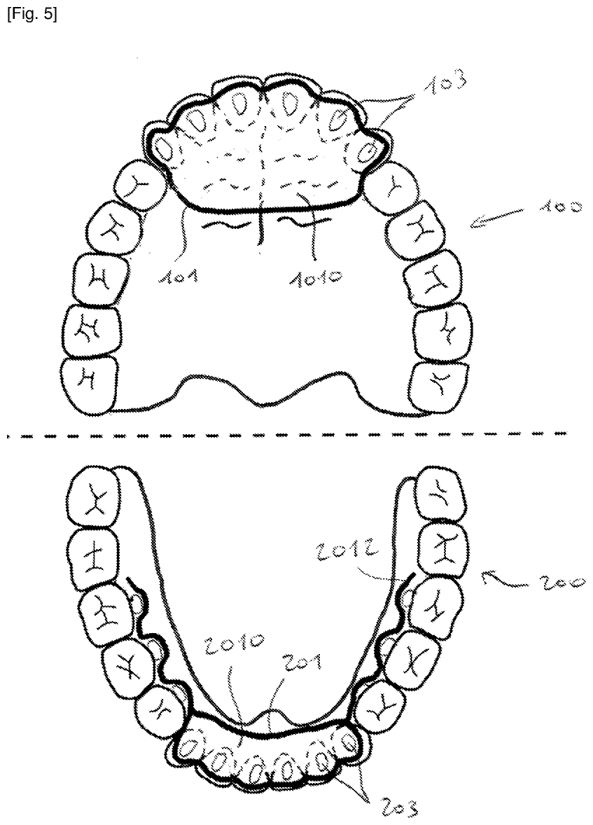

The connectors 103 may be attached on all or part of the teeth of a dental arch. In the example of FIG. 5, at the maxillary arch 100, the connectors 103 are attached to the lingual surface of the central incisors, lateral incisors and canines, the aligner 101 being positioned only at these teeth. At the arch 200, the connectors 203 are attached to the lingual surface of the central incisors, lateral incisors, canines, first premolars, second premolars and first molars, the aligner 201 being positioned only at these teeth.

The connectors 103, 203 may be made of the same polymer material as the aligner 101, 201, or of a distinct material, for example of metal or ceramic. The connectors 103, 203 may be obtained by molding, machining, 3D printing, etc. They are rigid, in that they are not deformed when stressed by the aligner.

To simplify their design and fitting, all the connectors 103, 203 are advantageously identical in size and in shape, regardless of the tooth to which they are attached and, regardless of the dental arch where they are positioned. It is possible however to provide different sizes and/or shapes according to the tooth and/or according to the dental arch and/or according to the type of stress to be applied and/or according to the intensity of the stress to be applied.

According to an embodiment, the aligner 101, 201 comprises a gripping member enabling the patient to grip it easily to disengage it from the connectors 103, 203. In FIG. 5, this gripping member 2012 is presented in the form of a notch shaped at one or more edges or at each (or a single) distal end of the aligner 201. This notch 2012 enables the patient to insert a nail or a finger therein to disengage the aligner 201. The gripping member 2012 may be presented in another form, for example in the form of an element in relief. The gripping member 2012 may be shaped at the same time as the aligner 101, 201 or be mounted thereon.

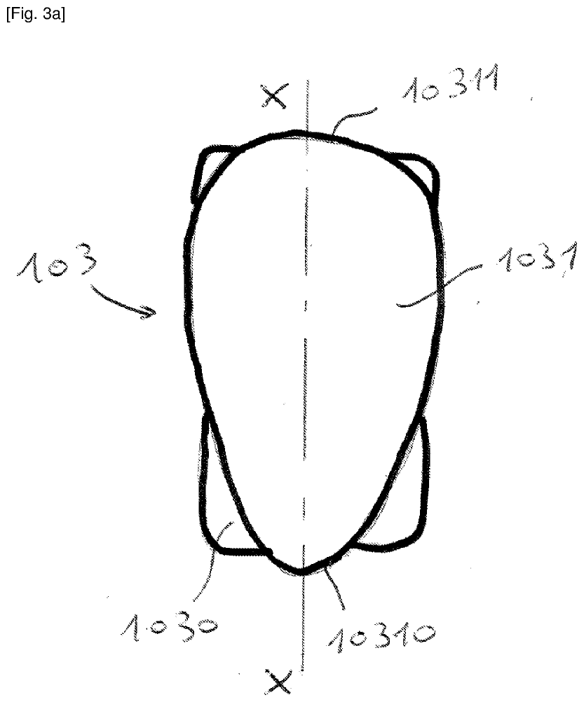

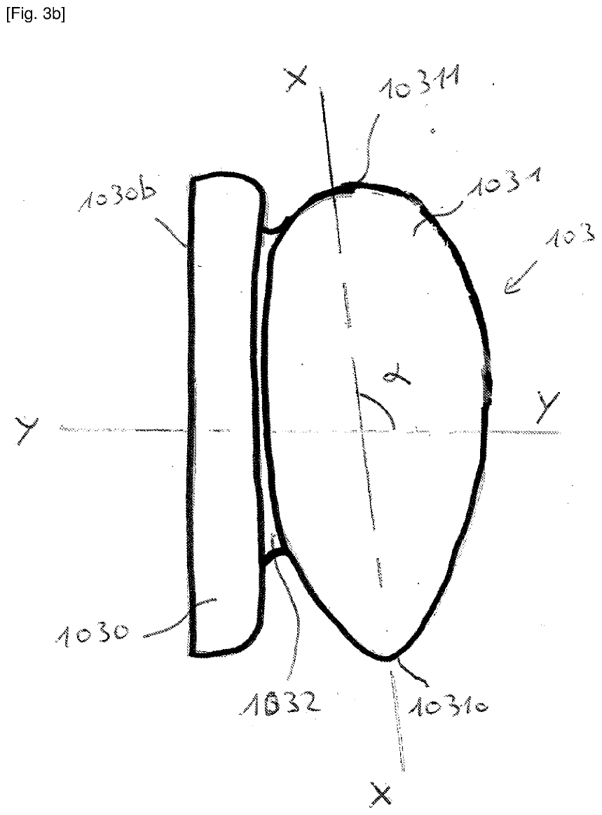

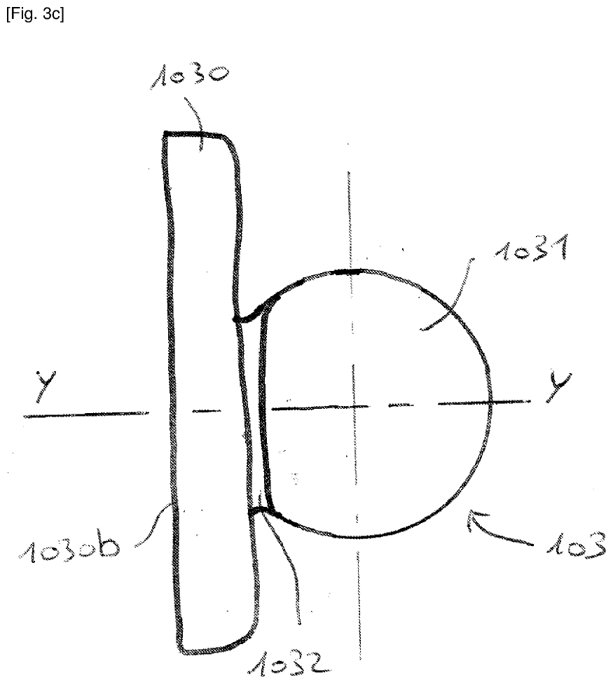

FIGS. 3a, 3b and 3c illustrate a preferred embodiment of a connector 103 which may be used universally, regardless of the tooth, regardless of the dental arch and regardless of the stress type and/or intensity to be applied.

This connector 103 comprises a base 1030 having an attachment surface 1030b adapted to be attached against the lingual surface 102b, 202b of a tooth. According to an embodiment, the base 1030 has a rectangular or substantially rectangular shape, of which the length is between 2 mm and 6 mm, the width is between 1 mm and 3 mm and the thickness between 0.5 mm and 2 mm. The base 1030 may however have other shapes, for example a circular, oval, polygonal shape, etc. The attachment surface 1030b may be planar, but preferably has a curvature adapted to that of the lingual surface 102b, 202b. According to an embodiment, the attachment of the base 1030 to the tooth is carried out by bonding, for example by means of a photo-polymerizable adhesive. The position of the connectors 103, 203 is kept throughout the treatment such that there is no need to change them at each step.

The connector 103 also comprises a connection head 1301 which is in line with the base 1030. In FIGS. 3a, 3b et 3c, the connection head 1301 is distant from the base 1030, for example at a distance of 0.5 mm to 2 mm, such that the connector 103 has a flange 1032 connecting said base from said head. This flange 1032 may in particular make it possible to receive a chain or an elastic band making it possible to apply a stress on the connector 103, when said chain or said elastic band is attached to another connector, to an anchor screw or to an orthodontic button. This technique may for example be used to pull an impacted tooth.

In FIGS. 3a, 3b and 3c, the connection head 1031 has an ovoid shape (or droplet or egg shape) having a longitudinal axis of symmetry X-X, or main axis. For example, this ovoid is included in a parallelepipedal envelope of which the length is between 2 mm and 6 mm, the width is between 1 mm and 6 mm and the depth between 1 mm and 6 mm.

Referring to FIG. 3b, the longitudinal axis of symmetry X-X and the normal Y-Y to the attachment surface 1030b of the base 1030, advantageously form an angle α between 10° and 90°, advantageously between 45° and 90° and preferably between 55° and 65°. This angulation of the ovoid connection head 1031 enables very precise control of dental movements, and more specifically version and torque.

The ovoid connection head 1031 has one end 10310 which is sharper than the other opposite end 10311. To control the dental movements (in particular version and torque) with an optimal precision, when the connector 103 is attached to a tooth, this “pointed” end 10310 is preferably directed toward the root of said tooth. Good results may however be obtained when the pointed end 10310 is directed toward the occlusal or incisal surface of the tooth. For dental movements such as a rotation, the pointed end 10310 may be directed toward the distal or mesial surface of the tooth.

After multiple trials, the inventor observed that such a connector 103, in particular with an ovoid connection head 1031, having an angulation relative to the base 1030 and of which the pointed end 10310 is directed toward the root of the tooth, made it possible not only to move the teeth along any chosen trajectory, with a very precise control of dental movements in the three dimensions, but also set with precision the intensity of the stresses applied on the teeth. Such a connector 103 may be described as universal insofar as a single shape and a single orientation make it possible to control with precision the six dental movements (version or tipping, egression, intrusion, rotation, torque, translation).

Good results in terms of precision of dental movements and of setting stress intensity, are also obtained when the connection head 1031 has an elongated ellipsoid shape of which the main axis is the longitudinal axis of symmetry X-X cited above. The two ends 10310 and 10311 are in this case identical and symmetrical.

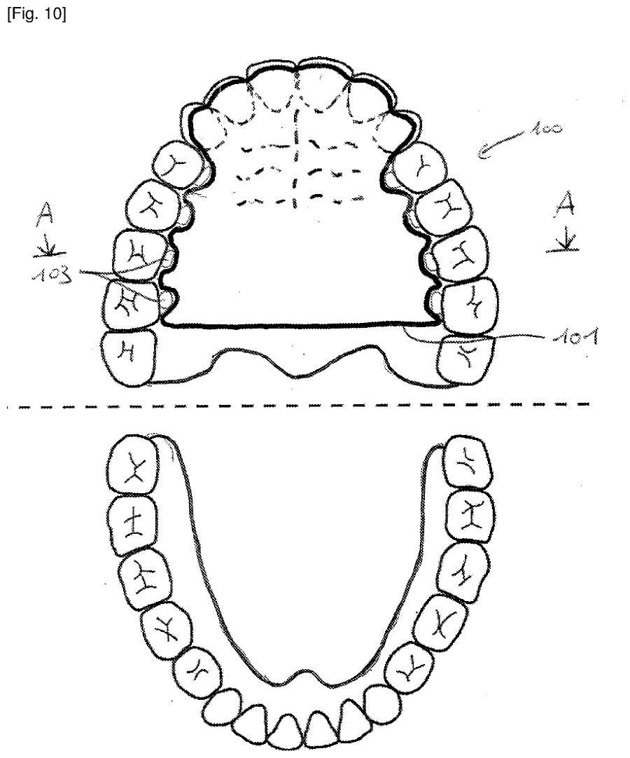

According to further embodiments, and in particular in the applications described hereinabove in the description with reference to FIGS. 10, 11 and 12a-12b, the connection head 1031 may have an ovoid or elongated ellipsoid shape or another shape and in particular a sphere, cube, parallelepiped, polyhedron, prism, cone, pyramid, cylinder shape, etc. It may furthermore consist of a combination or two or more of these different shapes.

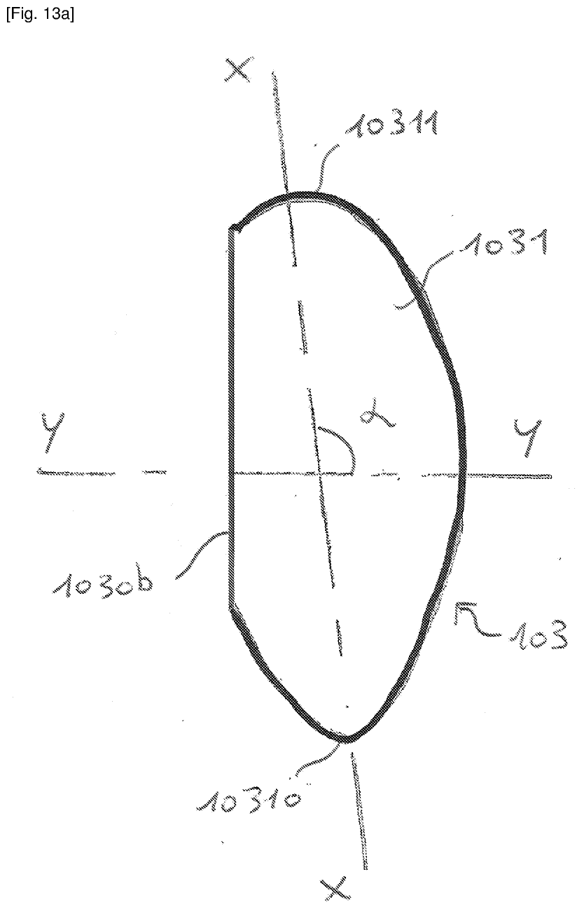

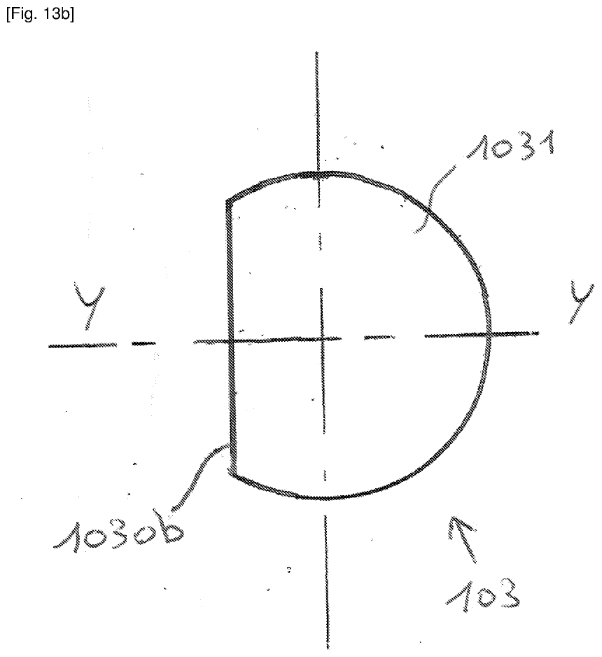

In the alternative embodiment of FIGS. 13a and 13b, the attachment surface 1030b consists of a flat section directly on the connection head 1031. The latter is then positioned as close to the lingual surface of the tooth as possible. This design offers the patient more comfort insofar as the size (in particular the thickness and/or the height) of the connector 103 is reduced compared to that of FIGS. 3a, 3b and 3c. Furthermore, the connection head 1031 being less overhanging compared to that of FIGS. 3a, 3b and 3c, the intensity and/or the nature of the stresses applied on the tooth are not the same.

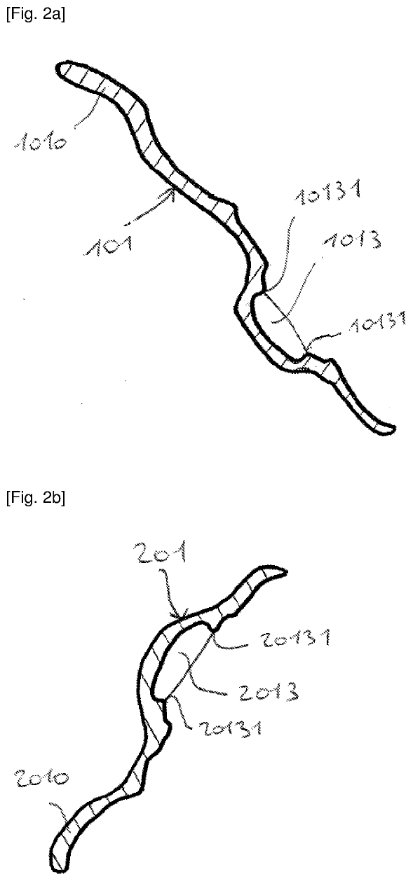

Referring to FIGS. 1, 2a and 2b, each aligner 101, 201 comprises pockets 1013, 2013 into which the connectors 103, 203 and more specifically the heads 1031, 2031 fit elastically. For the positioning of the aligner 101, 201, it is simply necessary to bring the pockets 1013, 2013 to face the heads 1031, 2031 and push said pockets onto said heads manually (with the fingers). The pockets 1013, 2013 form (non-through) cavities wherein the heads 1031, 2031 are housed. The pockets 1013, 2013 have a peripheral lip 10131, 20131 or another undercut shape which is deformed when the connectors 103, 203 are inserted and removed. After inserting the connectors 103, 203, the peripheral lip 10131, 20131 is coupled with the head 1031, 2031. It is noted here that ovoid or ellipsoid-shaped heads 1031, 2031 provide easy and painless release of the aligner 101, 201, without any risk of extracting the connectors 103, 203.

When the pockets 1013, 2013 are fitted into the connectors 103, 203 and the aligner 101, 201 is in position, said aligner exerts one or more stresses on the heads 1031, 2031 and optionally on the lingual surface of the teeth.

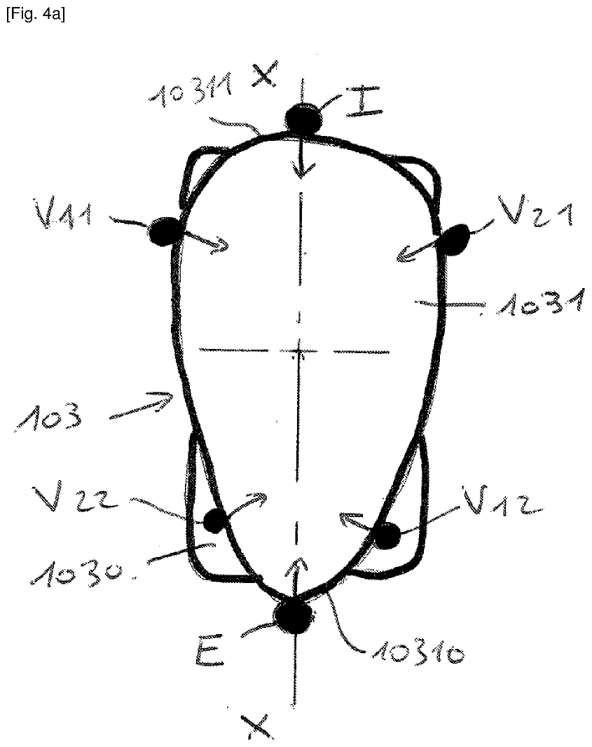

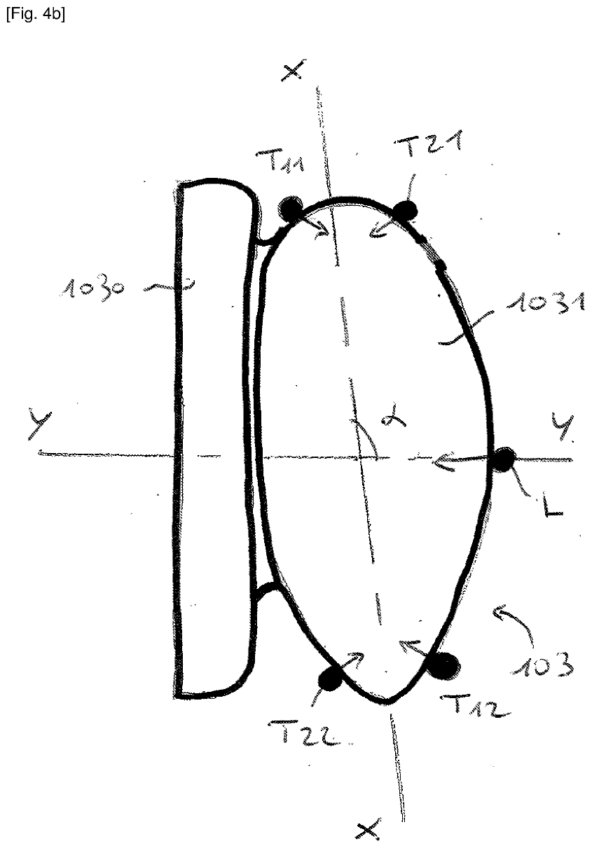

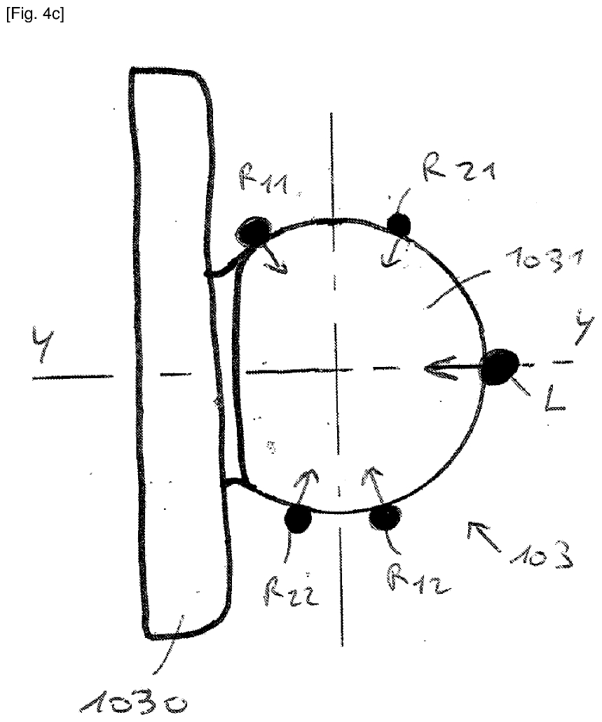

FIGS. 4a, 4b and 4c illustrate different stress zones of a connector 103 represented schematically by black dots. These stress zones correspond to points or surfaces of the head 1031 on which the aligner presses and/or exerts a pressure. These pressures are induced by the elastic deformation of the aligner during the treatment step in question. In other words, the aligner presses on one or more localized zones of the head 1031. The precise location of the stress zones may be determined by a specific configuration of the pockets 1013, 2013 and/or by the creation of bosses shaped by molding or produced by material addition (e.g.: resin) into said pockets. Insofar as the pocket 1013, 2013 surrounds and grips the head 1031, 2031 in the three dimensions, it is possible to readily obtain a three-dimensional control: each zone of the head may be stressed.

An intrusion movement is obtained by exerting a pressure in zone I (FIG. 4a), at the end 10311 (near the occlusal or incisal surface of the tooth), along the major axis of the tooth. This pressure will generate an axial force in the apical direction which tends to push the tooth into its socket.

Conversely, an egression movement is obtained by exerting a pressure in zone E (FIG. 4a), at the end 10310 (near the root of the tooth), along the major axis of the tooth. This pressure will generate an axial force in the occlusal direction which tends to push the tooth out of its socket.

A version (tipping) movement is obtained by exerting a pressure in zone V11 and/or in zone V12 (FIG. 4a). This pressure will trigger a rotation of the crown in a mesio-distal direction about an axis of vestibulo-lingual rotation. Furthermore, a pressure exerted in zone V21 and/or in zone V22 will trigger a reverse rotation of the crown in the disto-mesial direction about a vestibulo-lingual axis.

A torque movement is obtained by exerting a pressure in zone T11 and/or in zone T12 (FIG. 4b). This pressure will trigger a rotation of the crown in the vestibulo-lingual direction about a mesio-distal axis. Furthermore, a pressure exerted in zone T21 and/or in zone T22 will trigger a reverse rotation of the crown in the lingo-vestibular direction about a mesio-distal axis.

A rotation movement is obtained by exerting a pressure in zone R11 and/or in zone R12 (FIG. 4c). This pressure will trigger a rotation of the tooth about its major axis, in the disto-mesial direction. Furthermore, a pressure exerted in zone R21 and/or in zone R22 will trigger a rotation of the tooth in the mesio-distal direction about its major axis.

A translation movement is obtained by exerting a pressure in zone L (FIGS. 4b and 4c). This pressure will trigger a translation of the crown in the lingo-vestibular direction. A similar translation movement is obtained by exerting simultaneously a pressure in zones R21 and R12 (in addition to or instead of a pressure exerted in zone L). Furthermore, a pressure exerted simultaneously in zones R11 and R22 will trigger a reverse translation of the tooth in the vestibulo-lingual direction.

These different movements may be combined by exerting pressures simultaneously in different zones of the head 1031. For example, it is possible to combine a translation movement and a rotation movement by exerting simultaneously a pressure in zones L, R11 and R12. Similarly, it is possible to combine an egression movement and a version movement by exerting simultaneously a pressure in zones E and V11. All of these different dental movements may furthermore be amplified and/or set by stresses exerted by the aligner directly on the lingual surface of the teeth. Distinct stress zones are then obtained simultaneously on the connectors and on the lingual surface of the teeth.

The ovoid or ellipsoid shape of the head 1031, combined with the specific orientation of said head, make it possible to provide an infinity of stress zones (or thrust zones) which will help orient with precision the treatment forces exerted by the aligner, to induce one or more desired dental movements. The locations of the stress zones selected by the practitioner make it possible furthermore to set the intensity of the treatment forces exerted by the aligner. The dental movements, in the three dimensions, are thus set and controlled with a high precision.

Such a connector will make it possible to transmit with precision to the tooth, the treatment forces generated by the aligner. The connector is comparable to a kind of control stick or joystick for controlling the movements of the tooth to which it is attached. According to another analogy, the connection head is an avatar of the tooth onto which the connector is attached: the effects of the stresses applied on the tooth will be transmitted directly onto the tooth.

The connectors 103, 203 are attached to several teeth from an arch. However, the aligner 101, 201 will not necessarily apply treatment stresses to all of these teeth. Indeed, only some of these teeth need to be repositioned whereas others will serve as anchors to hold the aligner 101, 201 in place when it applies the stresses against the tooth or teeth to be repositioned.

So that the aligner 101, 201 can exert treatment stresses with a sufficient intensity on the connectors 103, 203 onto which it fits and/or on the teeth, it must press against a surface (law of action and reaction). The surfaces in contact with the aligner are those of the lingual surfaces 102b, 202b and those of the connection heads 1031, 2031. The connectors 103, 203 therefore make it possible to increase the overall contact surface area. However, this overall contact surface area is considerably less than that of a conventional Invisalign® splint type aligner which covers, in addition to the lingual surfaces 102b, 202b, the occlusal, incisal and vestibular surfaces of the teeth. At an equivalent modulus of elasticity, the aligner 101, 201 is therefore capable of exerting treatment stresses of lesser intensity on the connectors 103, 203 and/or on the teeth than Invisalign® splints. This may be problematic depending on the nature of the dental movements to be made, for example translation or rotation movements.

To solve this problem, one solution consists of using an aligner 101, 201 having an increased modulus of elasticity, for example by using a more rigid material and/or increasing the thickness of said aligners. This solution has, however, the drawback of being particularly painful and uncomfortable for the patient insofar as the intensity of the stresses may be relatively high locally.

In addition, a preferred solution consists of shaping the aligner 101, 201 so that it has an additional support zone. This additional support zone acts as a lever which will increase the intensity of the stresses exerted by the aligner 101, 201. In FIGS. 1, 2a, 2b and 5, the aligner 101 has a palatal extension 1010 configured to, when in use, press against all or part of the patient's palatal arch VP. According to an embodiment, the palatal extension 1010 extends beyond the gum zone, for example along 0.5 cm to 2 cm, to cover all or part of the palatine ridges (inter-canine width for example). For example, the surface area of the palatal extension 1010 is between 1 cm² and 3 cm². Similarly, the aligner 201 has a gum extension 2010 configured to, when in use, press against a gum zone ZG of the patient. According to an embodiment, the gum extension 1010 covers the gum zone along an arc, the length of which is between 1 cm and 4 cm (e.g.: an inter-canine arc) and up to the mucogingival junction. The surface area of this gum extension 2010 is for example between 0.5 cm² and 2 cm².

This solution has the advantage of retaining a relatively thin and flexible aligner 101, 201, not generating excessive stresses, and hence which is particularly comfortable for the patient.

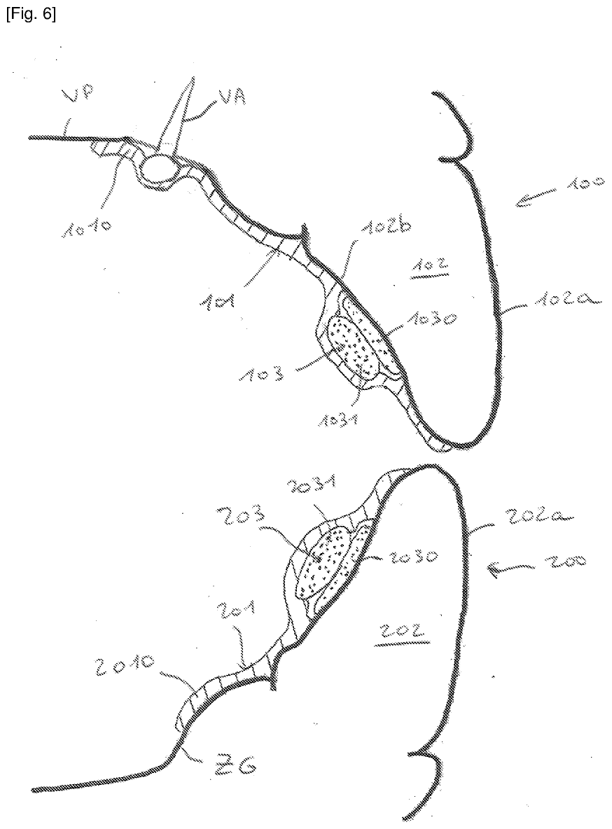

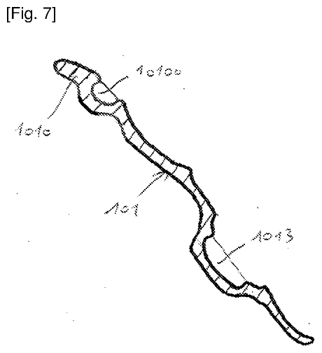

According to an embodiment illustrated in FIG. 6, the palatal extension 1010 is engaged with an anchor screw VA fitted in the patient's palate. The palatal extension 1010 has for this purpose a pocket 10100 (FIG. 7) into which the head of the screw VA fits. The aligner 101 thus benefits from an additional anchor point making it possible to increase the stress intensity even further. A similar configuration may be envisaged at the gum extension 2010.

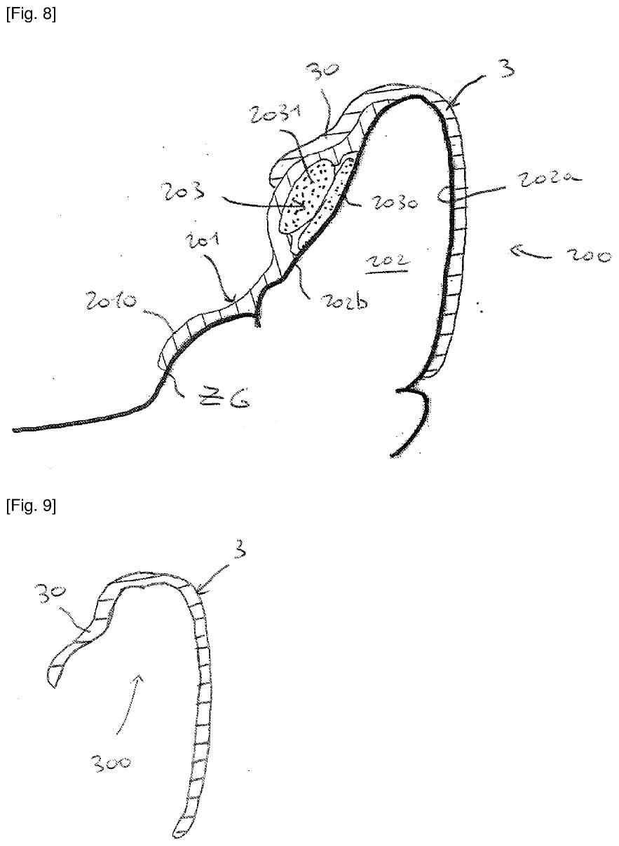

The embodiment illustrated in FIGS. 8 and 9, makes it possible to amplify further the stress exerted by the aligner 201 on the connection heads 2031 and/or on the lingual surfaces 202b of the teeth to be moved. In this embodiment, a removable splint 3 is profiled to cover some of the patient's teeth. This splint 3 has a portion 30 which engages on at least a part of the aligner 201 so as to apply on said aligner at least one force tending to stress it toward the lingual surface 202b of the teeth 202 that it covers and which are to be moved. The splint 3 is advantageously made of the same material as the aligner 201, and has the same thickness or a substantially equivalent thickness, such that it is flexible. This splint 3 may just as well be placed at the mandibular arch to cover the aligner 201 as at the maxillary arch to cover the aligner 101. The splint 3 being adapted to the shape of the aligner 201, there are as many splints as aligners in the treatment sequence.

Like an Invisalign® type splint, the splint 3 has a receiving cavity 300 which adapts to the teeth, for example to all the teeth of the dental arch on which it is positioned. The splint 3 can thus cover the vestibular surface 202a and the occlusal/incisal surface of these teeth. Among these teeth, those which do not cooperate with the aligner 201, the splint 3 also covers their lingual surface. In addition, for those which cooperate with the aligner 201, the portion 30 covers at least a part of said aligner. In FIG. 8, the portion 30 covers the aligner 201 up to the connector 203. It could however extend further, up to the gum. On account of the flexibility of the splint 3, the portion 30 acts as a grip on the aligner 201, which amplifies the stress exerted on the connection heads 2031 and/or on the lingual surfaces 202b of the teeth to be moved.

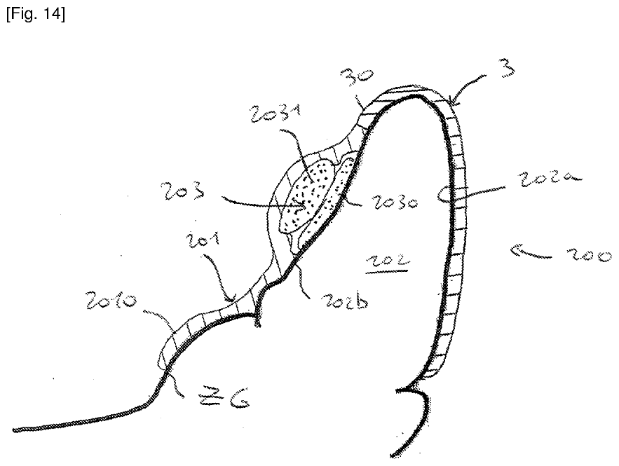

In FIG. 14, the portion 30 does not cover the aligner 201 but is complementary with the latter. Thus, for the teeth with which the aligner 201 cooperates: —the main part (for example between 80% and 95%) is their lingual surface is covered by said aligner; —and the other part of their lingual surface, their occlusal/incisal surface and their vestibular surface are covered by the splint 3. The portion 30 may cover a small part of the lingual surface, forming a lingual return which extends over a few millimeters (for example from 1 mm to 5 mm) of the occlusal/incisal edge of the tooth. The splint 3 thus acts upon the teeth (by applying a stress on them from the vestibular surface) but not on the aligner 201. This design is particularly advantageous from a manufacturing point of view. Indeed, it is simply necessary to design the aligner 201 and the splint 3 in one piece (for example by thermoforming) and subsequently cut said aligner (for example by laser cutting) to detach it from said splint. These two elements are thus obtained very simply and at least cost.

It should be noted that this splint 3 is not absolutely essential, insofar as the lingual aligner 101, 201 gives very good results when it is used alone. The splint 3 is merely an accessory, which is essentially used at night. It may also be used passively (without stressing the aligner and/or the teeth), as a retaining accessory at the end of treatment.

Orthodontic appliances such as stress-breakers or quad helix appliances are routinely used to expand an overly narrow jaw. The force exerted by these appliances enables the palate to expand so that all the teeth develop correctly. These appliances are generally restrictive insofar as their positioning may be relatively complex. In addition, in the case of a quad helix appliance, activation and setting are carried out by the practitioner at each check-up. Only the practitioner can modify the appliance, which is particularly restrictive. A dental appliance according to an embodiment not covered by the present invention makes it possible to solve these problems.

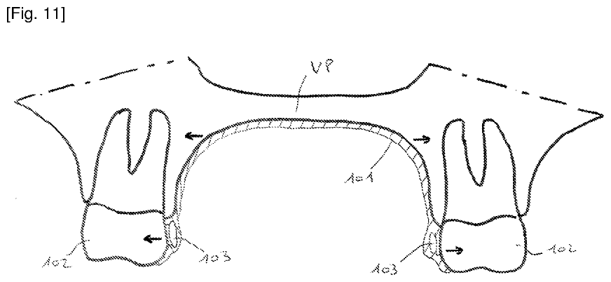

In FIGS. 10 and 11, the connectors 103 are attached to the lingual surface of the molars and premolars so as to ensure that the hold on the teeth is optimal. They may however be attached only onto the molars or onto other teeth.

The aligner is now presented in the form of a palatal plate 101 which covers the palate and which detachably engages (manually and without an instrument) on the connectors 103 as explained above. The plate 101 no longer has the function of aligning the teeth, but of expanding the palate (maxillary expansion plate). Indeed, the connectors 103 and the plate 101 cooperate so as to apply at least one stress on the teeth which tends to spread the palate in a transversal direction.

Similar to the aligner described above, the plate 101 is a flexible plate profiled to cover only the lingual surface 102b, 202b of the teeth while leaving the other surfaces of said teeth free. It also covers the palatal arch VP. The plate 101 comprises pockets into which the connectors 103 fit elastically.

Referring to FIG. 9, the flexible plate 101 presses on the palatal arch VP and acts as a spring or an actuator. The force (represented schematically by the arrows) exerted by the flexible plate 101 on the palatal arch VP and on the connectors 103 and the teeth 102 is oriented in the lingo-vestibular direction, which enables a spreading of the palate.

According to an embodiment, the flexible plate 101 presses against the lingual surface of several teeth of a quadrant or half-arch. And optionally of the teeth which are not provided with a connector 103, such as for example the incisors and the canines in FIG. 10. As a result, the flexible plate 101 enables a spreading of the palate in a transversal direction and at the same time in a sagittal direction, i.e., a curved or fan-shaped spreading. This is particularly advantageous when the appliance is worn by a growing child whose normal growth of the upper jawbone takes place in all directions and not only in the transversal direction. If only a spreading of the palate in a transversal direction is sought, the flexible plate 101 may be configured not to stress the molars.

The plate 101 fitting and detaching easily and manually from the connectors 103, the patient can manage their treatment themselves. Apart from fitting the connectors 103, the practitioner does not need to be involved. The patient has a series of plates 101 making it possible, at each step, to spread the palate progressively, for example by 0.1 mm to 0.2 mm. Each plate is increasingly wide to expand the palate. There may be between 10 and 100 steps and therefore between 10 and 100 different plate models 101. At the start of each step, when it is placed on the palate and engaged in the connectors, the plate 101 is adjusted to the intermediate (or final) configuration that the maxillary arch should have at the end of said step, such that each plate model 101 exerts stresses on the teeth which tend to expand the palate. The flexibility of the plate 101 enables it to deform elastically to the configuration that the arch has at the start of the step of the treatment. By attempting to return to its initial shape (shape memory), the plate 101 exerts stresses on the maxillary arch. The maxillary arch and the palate are then progressively adjusted to the shape of the plate 101. When the maxillary arch and the palate are perfectly adjusted to the shape of a plate 101, the latter is changed to move onto the next step of the treatment. The treatment may last from 1 to 6 months and the plates 101 changed once or twice per month.

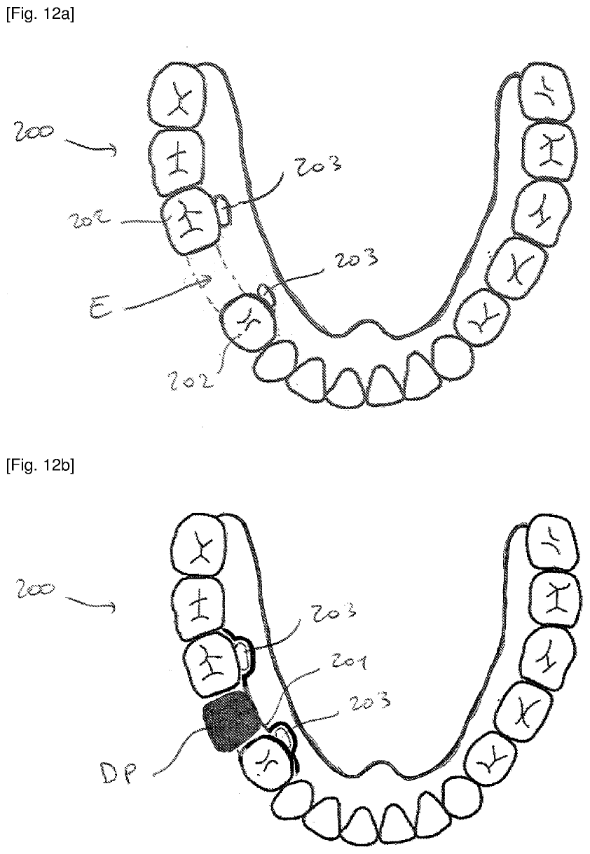

In FIG. 12a, connectors 203 are attached to the lingual surface of the teeth 202 which enclose a space E left free at the implantation site of an implant. For example, if the implant is fitted at the second premolar, the connectors 203 are attached to the lingual surface of the first premolar and the first molar. The space E may also be left free by a missing tooth. The connectors 203 are similar to the connectors 103 described above.

Referring to FIG. 12b, the device according to the invention comprises a support strip 201 onto which a dental prosthesis DP is attached. Conventionally, this prosthesis DP is made of resin and/or of ceramic. It is obtained by molding, machining or 3D printing.

The attachment of the prosthesis DP on the support strip 201 may be carried out by bonding, welding, fitting, or any other method suitable for a person skilled in the art. According to the embodiment of FIG. 12b, the lingual surface of the prosthesis DP is bonded to the support strip 201. According to an alternative embodiment, the prosthesis DP and the support strip 201 are a single unitary piece obtained by molding, machining or 3D printing.

As for the aligner described above, the support strip 201 engages on the connectors 203. It is presented in the form of a flexible or rigid strip, profiled to cover only the lingual surface of the teeth while leaving the other surfaces of said teeth free. It comprises pockets into which the connectors 203 fit elastically. The features of this support strip 201 are similar to those of the aligner 101 described above.

When the support strip 201 is fitted onto the connectors 203, the prosthesis DP fills the space E. The strip 201 no longer has the function of aligning the teeth, but of supporting the prosthesis DP. It also makes it possible to prevent the teeth from moving and keeps the space E, for example with a view to the future implantation or eruption of a permanent tooth in a child. It furthermore makes it possible to maintain occlusion by holding the antagonist tooth in the vertical position while preventing a regression thereof. As the support strip 201 is found hidden behind the teeth and the prosthesis DP, this solution is particularly attractive. Furthermore, the support strip 201 detachably engaging (manually and without an instrument) on the connectors 203, the prosthesis DP is positioned and removed very easily. The prosthesis DP may be merely temporary and be in particular removed from the end of the healing period, when the abutment and the definitive prosthesis are fitted. The prosthesis DP may be able be kept in position over a longer period, and acts as a definitive prosthesis (at least cost), for example in the case where the patient does not wish to continue the operation after fitting the implant.

Insofar as the strip 201 no longer has the function of aligning the teeth, it is advantageous that it is passive when it is fitted on the connectors 203. “Passive” means that the strip 201 does not exert movement stresses (or the least possible) on the teeth 202 which enclose the space E. To obtain this result, it appears to be advantageous to use connectors 203 for which the connection head is of spherical shape. The three-dimensional stresses exerted by such connectors on the teeth 202 are then zero, or at the very least substantially reduced.

The arrangement of the different elements and/or means and/or steps of the invention, in the embodiment described above, should not be understood as requiring such an arrangement in all the implementations. Further variants may be provided. In particular, the support strip 201 may be secured to several optionally adjacent dental prostheses.

Furthermore, one or more features described only in one embodiment can be combined with one or more further features described only in a further embodiment. Similarly, one or more features described only in one embodiment may be generalized to the other embodiments, even if this or these features are described only in combination with other features.

1.-12. (canceled)

13. A dental prosthesis support device comprising:
a support strip secured to a dental prosthesis;
connectors configured to be attached to the teeth of a patient, enclose a dental free space, and onto which the support strip detachably engages such that the dental prosthesis fills said space;
the support strip is profiled to cover only the lingual surface of said teeth while leaving the other surfaces of said teeth free;
the connectors are configured to be attached to the lingual surface of said teeth; and
the support strip comprises pockets into which the connectors fit elastically.

14. The dental prosthesis support device according to claim 13, wherein the dental prosthesis is attached to the support strip by one of bonding, welding, or fitting.

15. The dental prosthesis support device according to claim 13, wherein the dental prosthesis has a lingual surface which is bonded to the support strip.

16. The dental prosthesis support device according to claim 13, wherein the dental prosthesis and the support strip are a single molded, machined, or 3D-printed unitary piece.

17. The dental prosthesis support device according to claim 13, wherein each connection head includes a connection head of spherical shape.

18. The dental prosthesis support device according to claim 13, wherein each connector includes:
a base having an attachment surface configured to be attached against the lingual surface of a tooth; and
a connection head in line with the base and into which one of the pockets of the support strip fits.

19. The dental prosthesis support device according to claim 18, wherein the connection head is distant from the base, and a flange connects said base from said head.

20. The dental prosthesis support device according to claim 13, wherein each connector includes:
a connection head into which one of the pockets of the support strip fits,
an attachment surface configured to be attached against the lingual surface of a tooth, and
the attachment surface has a flat section arranged on the connection head.

21. The dental prosthesis support device according to claim 13, wherein the connection head has any one of the following shapes: ovoid, elongated ellipsoid, sphere, cube, parallelepiped, polyhedron, prism, cone, pyramid, and cylinder shapes; or is of a combination of two or more of: ovoid, elongated ellipsoid, sphere, cube, parallelepiped, polyhedron, prism, cone, pyramid, and cylinder shapes.

22. The dental prosthesis support device according to claim 13, wherein the support strip is flexible.

23. The dental prosthesis support device according to claim 13, wherein the support strip is rigid.

24. The dental prosthesis support device according to claim 13, wherein the support strip has portions or areas having distinct moduli of elasticity.
